(19) United States
(12) Patent Application Publication
(10) Pub. No.: US 2005/0079411 A1
(43) Pub. Date: Apr. 14, 2005

(54) Drawn and grooved battery can

(75) Inventors: Raymond G. Kairawicz, Watertown, CT (US); Warren E. Sweet, Naugatuck, CT (US)

Correspondence Address: WILLIAM C. CRUTCHER;MCCORMICK, PAULDING & HUBER, LLP, 185 ASYLUM STREET, CITY PLACE II, 18TH FLOOR, HARTFORD, CT, 06103-4102, US

(73) Assignee: Truelove & Maclean, Incorporated, Waterbury, CT (US)

(21) Appl. No.: 10/681,650

(22) Filed: Oct. 8, 2003

(51) Int. Cl. H01M 2/02; B21D 11/10

(52) U.S. Cl. 429/175; 429/164; 72/379.4

(57) ABSTRACT

A battery can for accommodating electrochemical materials includes an elongated and substantially cylindrical housing having wall with a smooth outer surface. The battery can further includes a plurality of lands and grooves formed on an inner surface of the wall which themselves define a substantially uniform and continuously repeating pattern on the inner surface.

### FIELD OF THE INVENTION

This invention relates in general to a battery can, and deals more particularly with a battery can having a plurality of longitudinal lands and grooves formed on the inside thereof for promoting increased battery performance.

### BACKGROUND OF THE INVENTION

Electrochemical cells are commonly employed to provide voltage for electrically operated devices, and are particularly well suited for portable electrically operated devices. One type of commonly known electrochemical cells are conventional alkaline cells which are of a generally cylindrical shape and are commercially available in sizes ranging from D, C, AA, AAA and AAAA, amongst other sizes and configurations.

Of great importance to manufacturers of electrochemical cells is the available energy density of the cells themselves. As utilized hereinafter, the term ‘energy density’ is defined as the energy obtainable per unit weight (gravimetric energy density) or per unit volume (volumetric energy density). Energy density is typically measured by determining the capacity and noting the average potential during discharge. Gravimetric (or ‘weight’) energy density is expressed in Wh/kg (watt-hours/kilogram), while volumetric energy density Wh/m3.

While there are many methods of increasing the overall energy density of electrochemical cells, including advancements being made in the nature of the electrochemical materials utilized therein, it has also been known to augment the manufacture of the battery can, i.e., the metal outer cylindrical shell, or can, of the electrochemical cell, itself.

In particular, attempts at making the outer longitudinal wall of the battery can as thin as possible, so as to increase the inner volume of the battery can, have resulted in increases in overall energy density. Still other configurations have relied upon a limited number of inwardly formed ribs to boost the energy density of electrochemical cells.

It has also been known to manufacture battery cans utilizing a Drawing and Ironing technique (DI). The known DI technique is also utilized to improve the volumetric energy density of the battery and employs a deep-drawing step using a press, followed by an ironing step using an ironing machine. While the DI technique is known for producing incidental, minor indentations on the inner surface of the battery can, on the order of approximately 1 micron, these indentations are neither uniform in size or shape, nor are they evenly distributed about the inner surface of the battery can.

With the foregoing problems and concerns in mind, it is the general object of the present invention to provide a battery can having increased performance characteristics.

It is another object of the present invention to provide a battery can having a thinner outer wall.

It is another object of the present invention to provide a battery can having an outer wall that varies in cross-sectional thickness.

It is another object of the present invention to provide a battery can having a plurality of longitudinal lands and grooves formed on the inside thereof.

It is another object of the present invention to provide a battery can having a plurality of substantially uniform longitudinal lands and grooves formed on the inner surface thereof.

### SUMMARY OF THE INVENTION

The present invention is generally a battery can having a plurality of longitudinal lands and grooves formed on the inner surface thereof, whereby the lands and grooves define a continuous and substantially repeating pattern across the entire inner surface area of the outer wall of the battery can.

Further, a preferred embodiment of the present invention includes a battery can having a plurality of lands and grooves extending longitudinally and for substantially an entire axial length of the battery can, whereby the longitudinally extending lands and grooves have a substantially uniform and continuously repeating sinusoidal pattern, as seen in cross-section.

These and other objectives of the present invention, and their preferred embodiments, shall become clear by consideration of the specification, claims and drawings taken as a whole.

### BRIEF DESCRIPTION OF THE DRAWINGS

FIG. 1 illustrates a perspective view of a grooved battery can, according to one embodiment of the present invention.

FIG. 2 illustrates a partially cut-away perspective view of the battery can shown in FIG. 1.

FIG. 3 illustrates an enlarged, partial cross-sectional view of the wall of the battery can shown in FIG. 1.

FIG. 4 is a comparison between a non-grooved battery can and a grooved battery can according to one embodiment of the present invention.

FIG. 5 is a manufacturing flow-diagram for producing the battery can of FIG. 1.

### DETAILED DESCRIPTION OF THE PREFERRED EMBODIMENT

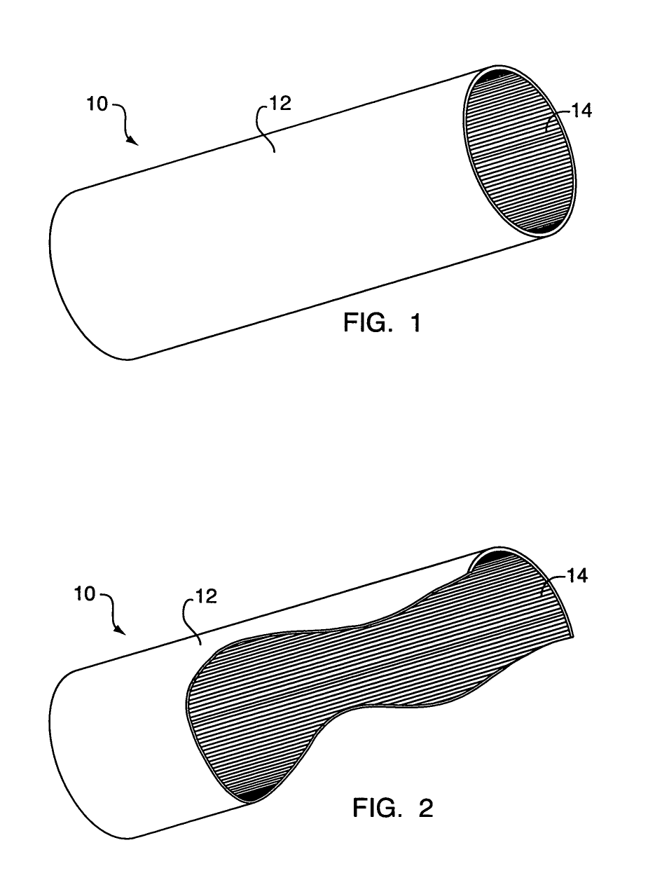

FIG. 1 illustrates a perspective view of a grooved battery can 10, according to one embodiment of the present invention. As shown in FIG. 1, the grooved battery can 10 includes a substantially smooth and cylindrical outer shell 12, preferably formed from a metal or metal-alloy composition. A pattern 14 on the inner surface of shell 12 is made up of longitudinally extending and alternating grooves 16 and lands 18.

FIG. 2 illustrates a partially cut-away isometric view of the battery can 10 shown in FIG. 1, and more clearly shows that the pattern 14 formed on the inner surface of the shell 12 extends substantially the entire length of the battery can 10. Moreover, as will be appreciated by a review of both FIGS. 1 and 2, the pattern 14 of circumferentially spaced lands and grooves is formed so as to be substantially uniformly distributed about the inner surface of the shell 12, thereby forming a continuous and substantially repeating pattern thereon.

It is therefore an important aspect of the present invention that the presence of the pattern 14 of the lands and grooves significantly increases the total internal surface area of the battery can 10, thus correspondingly increasing the capacity of the inner surface of the battery can 10 to contact the electrochemical materials housed therein. In this manner, the energy density of the battery can 10 is similarly increased.

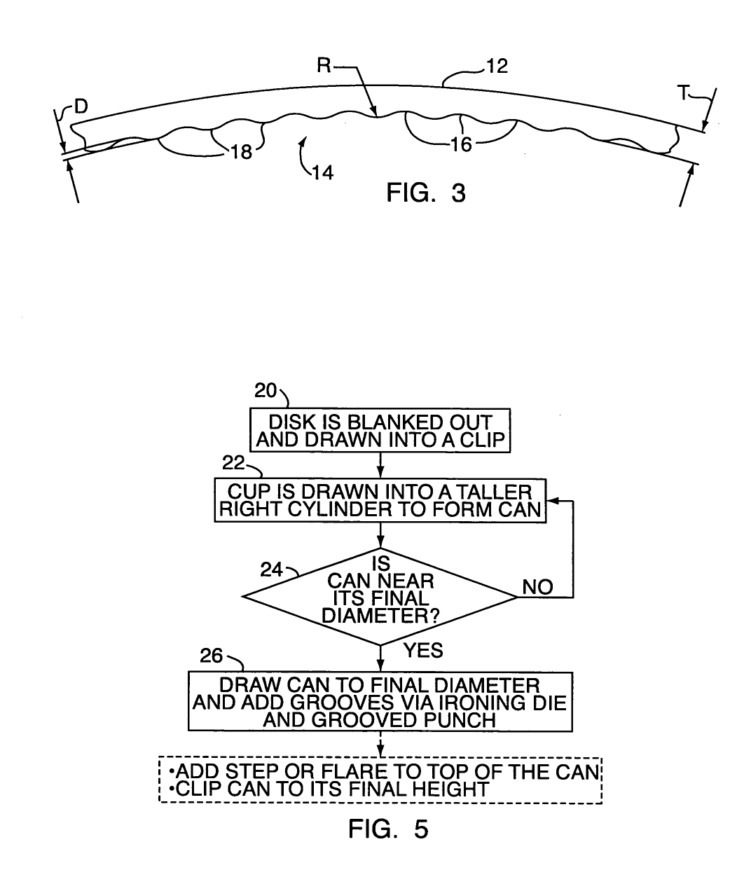

Moreover, it will be readily appreciated that by forming the lands 18 and the grooves 16, as best seen in FIG. 3, in a substantially uniform and repeating continuous pattern 14, as well as extending them substantially the entire longitudinal length of the battery can 10, the lands 18 and grooves 16 not only increase the internal surface area of the battery can 10, but do so in a manner which effectively maximizes any such increase in internal surface area. Thus, the particular configuration of the lands 18 and the grooves 16 depicted in FIGS. 1 and 2 not only increases, but serves to maximize the amount of potential contact between the inner surface of the battery can 10 and the active electrochemicals housed therein.

In a preferred embodiment of the present invention, approximately 100 to approximately 150 grooves 16, and a separate but substantially equal number of lands 18, may be formed about the inner surface of the battery can 10, assuming a standard AA-sized battery. More preferably, approximately 120 grooves 16 and 120 lands 18 are formed on the inner surface of the battery can 10 for a standard AA-sized battery. It will be readily appreciated that a correspondingly greater, or lesser, number of lands 18 and grooves 16 may be formed in batteries of differing sizes from that of a standard AA-type battery, in dependence upon the actual dimensions of the lands 18 and grooves 16, as will be discussed in more detail later.

In addition to increasing the internal surface area of the battery can 10, the present invention also increases the total internal volume of the battery can 10 by reducing the total average thickness of the shell 12. FIG. 3 illustrates an enlarged, partial cross-sectional section of the shell 12 wherein the greatest thickness, T, of the shell 12 is approximately 0.008 inches, as measured at the lands 18, while being selectively and substantially uniformly reduced to 0.006 inches, as measured in the areas of the grooves 16. That is, the present invention contemplates forming a plurality of circumferentially spaced, repeating and substantially uniform grooves 16 having an average depth, D, of approximately 0.002 inches, or approximately 25% of the maximum thickness, T, of the shell 12.

It is therefore another important aspect of the present invention that the architecture of the battery cell 10, as perhaps best seen in cross-section in FIG. 3, enables a significant reduction in the total average thickness of the shell 12, while also ensuring that the shell 12 maintains its structural integrity.

Moreover, it has been determined that the minimum value for the depth, D, of the grooves 16 is in the range of approximately 0.0005 inches to approximately 0.001 inches, as any lesser depth would have only a negligible effect on the total internal surface area and internal volume of the battery can 10. Conversely, the maximum value for the depth, D, of the grooves 16 is dependent upon the concern that no cross-sectional portion of the shell 12 ever falls below approximately 0.004 inches, thereby ensuring the structural stability and durability of the battery can 10.

It will also be noted by a review of FIG. 3 that the undulating inner surface of the battery can 10 is substantially sinusoidal in cross-section. Such a configuration has proven most effective from a tooling perspective and has resulted in the greatest increase in internal surface area as compared to other, differing cross-sectional configurations.

Turning to the radii, R, of the raised-area lands 18 shown in FIG. 3, the present invention contemplates a minimum radius, R, of approximately 0.005 inches when a sinusoidal geometry is utilized in the formation of the lands 18 and grooves 16. It has been determined that any radii, R, substantially smaller than 0.005 inches would significantly weaken the structure of the punch that forms the lands 18 and grooves 16, the process of which will be described in more detail later.

It is therefore another important aspect of the present invention that a sinusoidal cross-sectional geometry is utilized not only to ensure the greatest possible increase in internal surface area while still maintaining the structural integrity of the shell 12, but also because differing cross-sectional patterns, such as rectangular, trapezoidal or V-shaped patterns, have been shown to weaken the punch that forms the lands and grooves 14 if employed at a scale commensurate with lands 18 of 0.005 inches of radii, R, utilized in conjunction with the sinusoidal pattern of FIG. 3.

That is, in the formation of very fine and numerous lands 18 and grooves 16, on the order of approximately 120-150 for a standard AA-type battery, the sinusoidal cross-sectional geometry is preferred as maximizing the number of lands 18 and grooves 16 to the greatest practical extent, given the practical constraints of the punch tooling utilized in their formation. However, it should be noted that should the ratio of the number of the lands 18 and grooves 16 to the inner surface area, or circumference, of the battery can 10 decrease, differing cross-sectional configurations, such as rectangular, trapezoidal or V-shaped cross-sectional patterns, may be utilized without harming the punch tooling or departing from the broader aspects of the present invention.

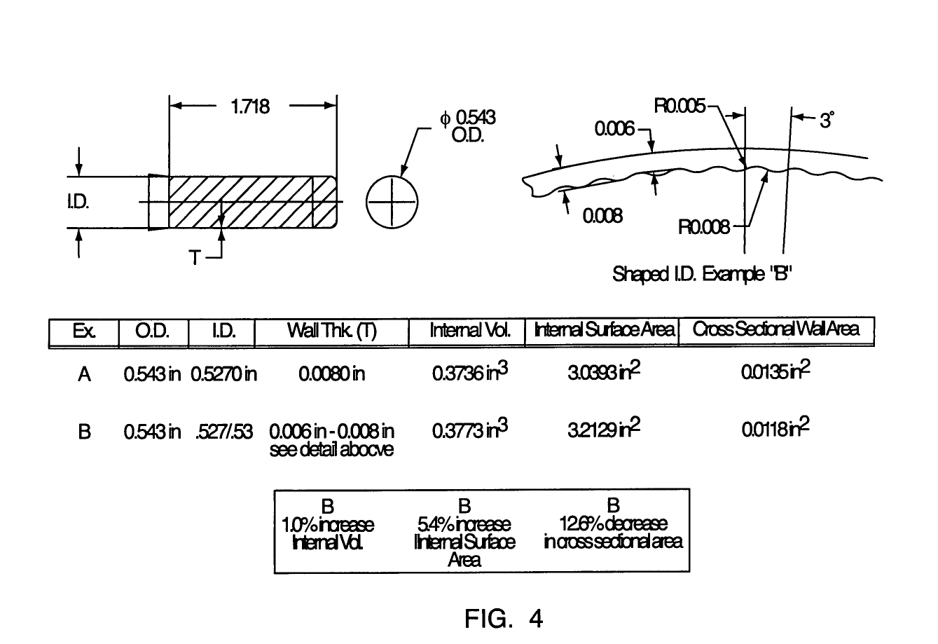

FIG. 4 illustrates a comparison between a conventionally formed battery can, A, and a battery can, B, formed in accordance with the present invention. As shown in FIG. 4, the outer diameters of both A and B are equal, in accordance with a hypothetical standard-sized battery. The outer wall, or shell, thickness, T, is constant for the conventionally formed battery can A, while the outer wall thickness T of battery can B undulates in accordance with the present invention from approximately 0.008 inches to approximately 0.006 inches, as discussed previously.

As compared to the conventionally formed battery can A, the internal volume of battery can B has increased from 0.3736 cubic inches to 0.3773 cubic inches, or by approximately 1.0%. Similarly, the internal surface area of battery can B has increased from 3.0393 square inches to 3.2129 square inches, an increase of approximately 5.4%, while the cross-sectional wall area of battery can B has decreased from 0.0135 square inches to 0.0118 square inches, a decrease of approximately 12.6%.

As will be appreciated, the increases in both the internal volume and the internal wall surface area of the battery can 10, as well as the decrease in the cross-sectional wall area, result in a electrochemical cell which is capable of housing a greater volume of electrochemical materials, while providing for more contact between the shell 12 and these electrochemical materials—all without increasing the outer dimensional characteristics of the battery can 10. The net effect of such an architecture is to create a battery can 10 capable of exhibiting greater energy density, without sacrificing either structural stability or standard dimensional requirements.

The process by which the battery can 10 is formed will now be described. A Drawn and Ironed (DI) process is utilized for formation of the battery can 10 and generally involves utilizing a transfer press having a plurality of grooves formed thereon so as to provide the longitudinally extending lands and grooves 14 to the inner surface of the battery can 10.

As shown in step 20 of FIG. 5, a disk is first blanked out of a suitable, typically metallic, material and drawn to form a rough cup shape. The cup is then drawn into a taller right cylindrical shell to form a can-shaped workpiece, in step 22. Step 24 indicates that the drawing of the can workpiece continues in this manner from the transfer press stage to the next, until the can workpiece enjoys a diameter approximate to its final diameter. The can workpiece is then transferred to the final drawing station where the can workpiece is drawn to its final diameter and the grooves are added using an ironing die and a grooved punch in step 26. Step 28 illustrates that the top of the now-drawn and grooved battery can may now be flared or stepped, as well as being clipped to its final height.

In the process disclosed in FIG. 5, the entire inner surface of the battery can 10 is ironed. That is, the raised-area lands 18 are ironed approximately 20% while the grooves 16 are ironed approximately 40%. With such a process, the Ra roughness of the grooves 16 is approximately 28 microinches. While the process has been explained as ironing the lands 18 by approximately 20%, the present invention is not so limited in this regard as the lands 18 may be ironed to as low as 0% without departing from the broader aspects of the present invention.

While the grooved battery can 10 has been described in conjunction with an AA-sized battery, the present invention is not so limited in this regard as the formation of uniform and continuous longitudinally formed grooves may be alternatively employed in batteries of any size or shape.

While the invention has been described with reference to the preferred embodiments, it will be understood by those skilled in the art that various obvious changes may be made, and equivalents may be substituted for elements thereof, without departing from the essential scope of the present invention. Therefore, it is intended that the invention not be limited to the particular embodiments disclosed, but that the invention includes all embodiments falling within the scope of the appended claims.

1. A battery can for accommodating electrochemical materials therein, said battery can comprising:
an elongated and substantially cylindrical shell, said shell having a wall with a smooth outer surface, said wall having an inner surface; and
a plurality of lands and grooves formed on said inner surface of said wall, said lands and grooves defining a substantially uniform and continuously repeating pattern on said inner surface.

2. The battery can according to claim 1, wherein:
said lands and grooves extend longitudinally and for substantially an entire axial length of said battery can.

3. The battery can according to claim 1, wherein:
said substantially uniform and continuously repeating pattern on said inner wall is a sinusoidal pattern in cross-section.

4. The battery can according to claim 1, wherein:
said substantially uniform and continuously repeating pattern is one of a rectangular, a trapezoidal and a v-shaped pattern in cross-section.

5. The battery can according to claim 1, wherein:
said grooves extend into said wall by an amount approximately equal to 25% of a cross-sectional thickness of said wall.

6. The battery can according to claim 1, wherein:
no portion of an axial length of said shell is below approximately 0.004 inches in cross-sectional thickness.

7. The battery can according to claim 3, wherein:
a minimum radii of said lands of said sinusoidal pattern is approximately equal to 0.005 inches.

8. The battery can according to claim 1, wherein:
said battery can is a AA-sized battery can; and
approximately 100 to 150 of said grooves are defined on said inner surface.

9. The battery can according to claim 1, wherein:
said battery can is a AA-sized battery can; and
approximately 120 of said grooves are defined on said inner surface.

10. A method of forming a battery can with lands and grooves on an inner surface area thereof, said method comprising the steps of:
providing a metallic disk;
drawing said disk into a substantially cylindrical can workpiece;
repeatedly drawing said can workpiece until said can workpiece has a predetermined diameter; and
utilizing a shaped punch and an ironing die to define said lands and grooves in said inner surface area of said battery can.

11. The method of forming a battery can according to claim 10, said method further comprising the steps of:
utilizing said shaped punch and an ironing die to produce said lands and grooves having a substantially uniform and continuously repeating pattern.

12. The method of forming a battery can according to claim 10, said method further comprising the steps of:
producing said lands and grooves so that they extend longitudinally and for substantially an entire axial length of said battery can.

13. The method of forming a battery can according to claim 10, said method further comprising the steps of:
utilizing said shaped punch and ironing die to define said lands and grooves having a substantially uniform and continuously repeating sinusoidal pattern in cross-section.

14. The method of forming a battery can according to claim 10, said method further comprising the steps of:
utilizing said shaped punch and ironing die to define said lands and grooves having one of a rectangular, a trapezoidal and a v-shaped pattern in cross-section.

15. The method of forming a battery can according to claim 10, said method further comprising the steps of:
extending said lands and grooves into said housing by an amount approximately equal to 25% of a cross-sectional thickness of said housing.

16. The method of forming a battery can according to claim 10, said method further comprising the steps of:
ensuring that no portion of said housing is below approximately 0.004 inches in cross-sectional thickness.

17. The method of forming a battery can according to claim 13, said method further comprising the steps of:
ensuring that a minimum radii of said lands of said sinusoidal pattern is approximately equal to 0.005 inches.

18. The method of forming a battery can according to claim 10, said method further comprising the steps of:
sizing said battery can to be a AA-sized battery can; and
defining approximately 100 to 150 of said grooves on said inner surface area.

19. The method of forming a battery can according to claim 10, said method further comprising the steps of:
sizing said battery can to be a AA-sized battery can; and
defining approximately 120 of said grooves on said inner surface area.

20. The method of forming a battery can according to claim 10, said method further comprising the steps of:
ironing said lands approximately 20%; and
ironing said grooves approximately 40%.

21. A battery can for accommodating electrochemical materials therein, said battery can comprising:
an elongated and substantially prismatic shell, said shell having a wall with a smooth outer surface, said wall having an inner surface; and
a plurality of lands and grooves formed on said inner surface of said wall, said lands and grooves defining a substantially uniform and continuously repeating pattern on said inner surface.

22. The battery can according to claim 21, wherein:
said lands and grooves extend longitudinally and for substantially an entire axial length of said battery can.

23. The battery can according to claim 21, wherein:
said substantially uniform and continuously repeating pattern on said inner wall is a sinusoidal pattern in cross-section.

24. The battery can according to claim 21, wherein:
said substantially uniform and continuously repeating pattern is one of a rectangular, a trapezoidal and a v-shaped pattern in cross-section.

25. The battery can according to claim 21, wherein:
said grooves extend into said wall by an amount approximately equal to 25% of a cross-sectional thickness of said wall.

26. The battery can according to claim 21, wherein:
no portion of an axial length of said shell is below approximately 0.004 inches in cross-sectional thickness.

27. The battery can according to claim 23, wherein:
a minimum radii of said lands of said sinusoidal pattern is approximately equal to 0.005 inches.

28. A method of forming a battery can with lands and grooves on an inner surface area thereof, said method comprising the steps of:
providing a metallic disk;
drawing said disk into a substantially prismatic prismatic can workpiece;
repeatedly drawing said can workpiece until said can workpiece has a predetermined diameter; and
utilizing a shaped punch and an ironing die to define said lands and grooves in said inner surface area of said battery can.

29. The method of forming a battery can according to claim 28, said method further comprising the steps of:
utilizing said shaped punch and an ironing die to produce said lands and grooves having a substantially uniform and continuously repeating pattern.

30. The method of forming a battery can according to claim 28, said method further comprising the steps of:
producing said lands and grooves so that they extend longitudinally and for substantially an entire axial length of said battery can.

31. The method of forming a battery can according to claim 28, said method further comprising the steps of:
utilizing said shaped punch and ironing die to define said lands and grooves having a substantially uniform and continuously repeating sinusoidal pattern in cross-section.

32. The method of forming a battery can according to claim 28, said method further comprising the steps of:
utilizing said shaped punch and ironing die to define said lands and grooves having one of a rectangular, a trapezoidal and a v-shaped pattern in cross-section.

33. The method of forming a battery can according to claim 28, said method further comprising the steps of:
extending said lands and grooves into said housing by an amount approximately equal to 25% of a cross-sectional thickness of said housing.

34. The method of forming a battery can according to claim 28, said method further comprising the steps of:
ensuring that no portion of said housing is below approximately 0.004 inches in cross-sectional thickness.

35. The method of forming a battery can according to claim 31, said method further comprising the steps of:
ensuring that a minimum radii of said lands of said sinusoidal pattern is approximately equal to 0.005 inches.

36. The method of forming a battery can according to claim 28, said method further comprising the steps of:
ironing said lands approximately 20%; and
ironing said grooves approximately 40%.
